(19) United States
(12) Patent Application Publication
(10) Pub. No.: US 2008/0027818 A1
(43) Pub. Date: Jan. 31, 2008

(54) METHOD FOR SELLING A BUSINESS

(76) Inventor: Tom Broadhead, Glen Allen, VA (US)

Correspondence Address: HAHN LOESER & PARKS, LLP, One GOJO Plaza, Suite 300, AKRON, OH, 44311-1076, US

(21) Appl. No.: 11/460,508

(22) Filed: Jul. 27, 2006

(51) Int. Cl. G06Q 30/00

(52) U.S. Cl. 705/26

(57) ABSTRACT

A system for brokering the sale of a business includes a put option that guarantees the sale of the business if the business is not otherwise sold within the prescribed time limit. The system calculates an offer price from historical data about the business being sold and sets a guarantee price proportionate to the offer price. If the business does not sell, the broker purchases the business at the guaranteed price or finds another buyer to purchase the business at a later time.

### TECHNICAL FIELD

The present invention pertains to methods of brokering a business, and more particularly, to methods of brokering a business by guaranteeing the sale of the business at a guaranteed purchase price.

### BACKGROUND OF THE INVENTION

Business owners choose to sell their business for a variety of reasons. One common reason for selling a business relates to executive burn out. The constant pressure and concerns of the business tax even the most tenacious personality. Illness is another reason that compels some business owners to sell their business. It is not uncommon for a business owner who is experiencing health problems to decide to circumvent the long term affects of stress by selling their business. Other reasons also exist for selling a business. These may include more private issues such as a desire to “cash out”, divorce or even boredom with the day to day operations of the business. Still, other reasons relate to the business itself. Such examples may include business owners who sell because of a lack of working capital or because the business has grown beyond their management capabilities.

Whatever the reason, business owners frequently acquire the services of a business broker to help sell their business. While some business owners choose to sell their business themselves, the problems of finding the right buyer at the right price often drives a business owner to a broker. A broker possesses a network of contacts and the experience to match a particular buyer to a given business. The broker also functions as a negotiator or buffer between the buying and selling parties, which is frequently beneficial to preserving the working relationship between two parties after the sale has been transacted. A good broker brings to the table a current knowledge of the marketplace, which helps them price companies at high but achievable levels, and contacts with sources of financing. In instances where the seller isn't willing to accept an extended payment schedule, a well-connected broker may be able to solidify the deal by introducing the buyer to the right lender.

Unlike selling a building or residential home, selling a business may depend upon a wider variety of factors. In many instances a smooth transition is required to help establish the new owners. Accordingly, consulting agreements may be worked into the terms of the sale. Other aspects of selling a business may include confidentiality, which is to say that public knowledge of selling a business may be detrimental to the existing business and the negotiating process. For these and other reasons, a business owner may utilize the services of a business broker to sell their business.

In certain situations, some of which are alluded to above, it is desirable to sell a business as quickly as possible. However, depending on the size and nature of the business, it may take a considerable amount of time to find the right people who have the resources and background to purchase a business. With upper-end deals, in which the buyers are usually large companies or investment groups rather than individuals, the sale of a business may take longer than the time frame in which the seller has to sell his business. Accordingly, it would be advantageous to have a measure of assurance that the sale of a business would sell by a given time frame. The following system and methods obviate the aforementioned concerns about selling a business within a specific time frame.

### BRIEF SUMMARY

The present invention relates to a method for guaranteeing the sale of a business that includes the steps of providing a processor based network, which may be a microprocessor based network of computers, capable of storing and retrieving operating data about a business being offered for sale by a business broker or a separate entity, receiving operating data from the business, storing the operating data in a database within the processor based network, calculating an offer price for the business based on the operating data, calculating a guaranteed purchase price, and guaranteeing the sale of the business.

In one embodiment, the method includes finding a third party purchaser to purchase the business at the guaranteed purchase price responsive to not receiving an offer from an associated buyer, and guaranteeing the sale of the business within a prescribed time limit if an offer from an associated buyer is not received.

In another embodiment, the method includes providing an option to sell the business at the guaranteed purchase price when the business does not receive a minimum bid offer thereby guaranteeing the sale of the business.

One aspect of the embodiments of the subject invention includes a processor based network that is administrated by a first entity where the first entity may be a business broker, an investor, a potential purchaser or any other party.

Still another aspect of the embodiments of the subject invention includes a processor based network that is administrated by a first entity where the business is being sold by an entity other than the first entity.

Another aspect of the embodiments of the subject invention includes providing an algorithm operable to process the operating data, and automatically calculate an offer price for the business based on the operating data.

Another aspect of the embodiments of the subject invention includes automatically calculating a guaranteed purchase price based on a percentage of the offer price.

Yet another aspect of the embodiments of the subject invention includes updating the operating data from the business and recalculating the offer price based on the updated operating data.

Even another aspect of the embodiments of the subject invention includes generating at least a first report from the processor based network.

Still another aspect of the embodiments of the subject invention includes authorizing one or more users access to the processor based network and restricting access of the users to subsets of the information stored in the database.

In another embodiment of the subject invention a method is provided that comprises the steps of receiving operating data about a business, wherein the business is being offered for sale by a business broker or other entity, valuating the business and/or calculating an offering price for the business based on the operating data, calculating a guaranteed purchase price for the business, listing the business for sale for a prescribed listing time period, and guaranteeing the sale of the business for the guaranteed purchase price responsive to the sale of the business within the prescribed listing time period.

In another embodiment of the subject invention a method is provided that comprises the steps of receiving operating data about a business, wherein the business is being offered for sale by a business broker or other entity, valuating the business and/or calculating an offering price for the business based on the operating data, calculating a guaranteed purchase price for the business, and guaranteeing the sale of the business for the guaranteed purchase price for a predetermined period of time.

One aspect of the embodiments of the subject invention includes charging a fee for providing the option to sell the business at the guaranteed purchase price. The fee for providing the option to sell the business at the guaranteed purchase price may be based one or more factors including: valuating the business, the number of months that the option to sell the business at the guaranteed purchase price will last, or the length of time that the business will be listed for sale.

One aspect of the embodiments of the subject method includes securing a third party purchaser to purchase the business at the guaranteed purchase price.

Another aspect of the embodiments of the subject method includes a guaranteed purchase price that is between 50% and 90% of the offering price, and more specifically between 70% and 85% of the offering price.

Yet another aspect of the embodiments of the subject method includes extinguishing the guarantee responsive to receiving a minimum bid offer from an associated buyer.

### BRIEF DESCRIPTION OF THE DRAWINGS

FIG. 1 is a schematic representation of a guaranteed purchase price system showing a business broker and various business entities according to the embodiments of the invention.

FIG. 2 is a schematic representation of a guaranteed purchase price system showing a processor based network according to the embodiments of the invention.

FIG. 3 is a schematic representation of a guaranteed purchase price system showing a business broker and various business entities according to the embodiments of the invention.

FIG. 4 is a flow chart showing an embodiment of the sequence of events of the guaranteed purchase price system according to the embodiments of the invention.

FIG. 4a is a flow chart showing an embodiment of the sequence of events of the guaranteed purchase price system according to the embodiments of the invention.

FIG. 5 is a block diagram of a method of guaranteeing the sale of a business according to the embodiments of the invention.

FIG. 6 is a block diagram of a method of guaranteeing the sale of a business according to the embodiments of the invention.

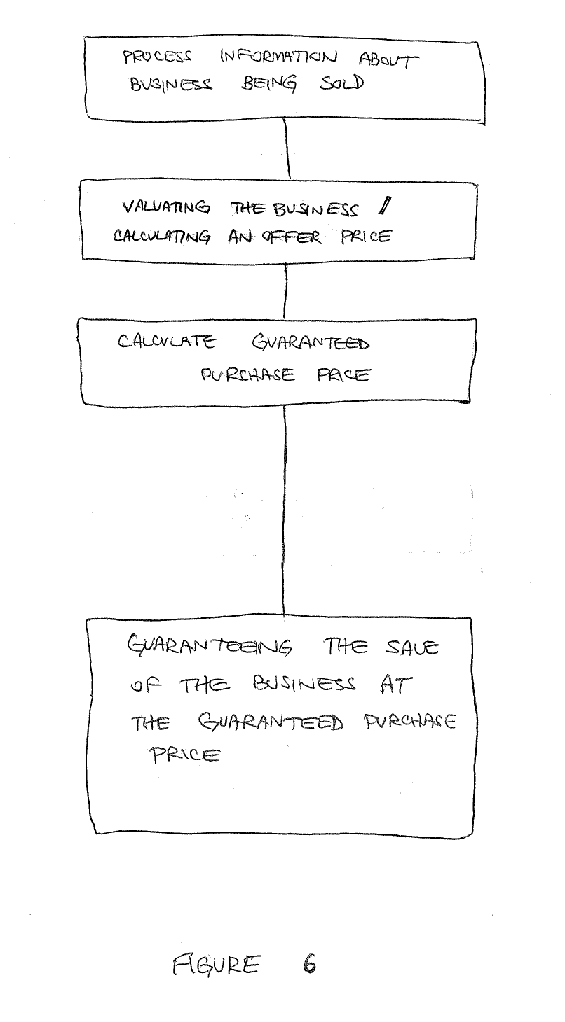

### DETAILED DESCRIPTION OF THE INVENTION

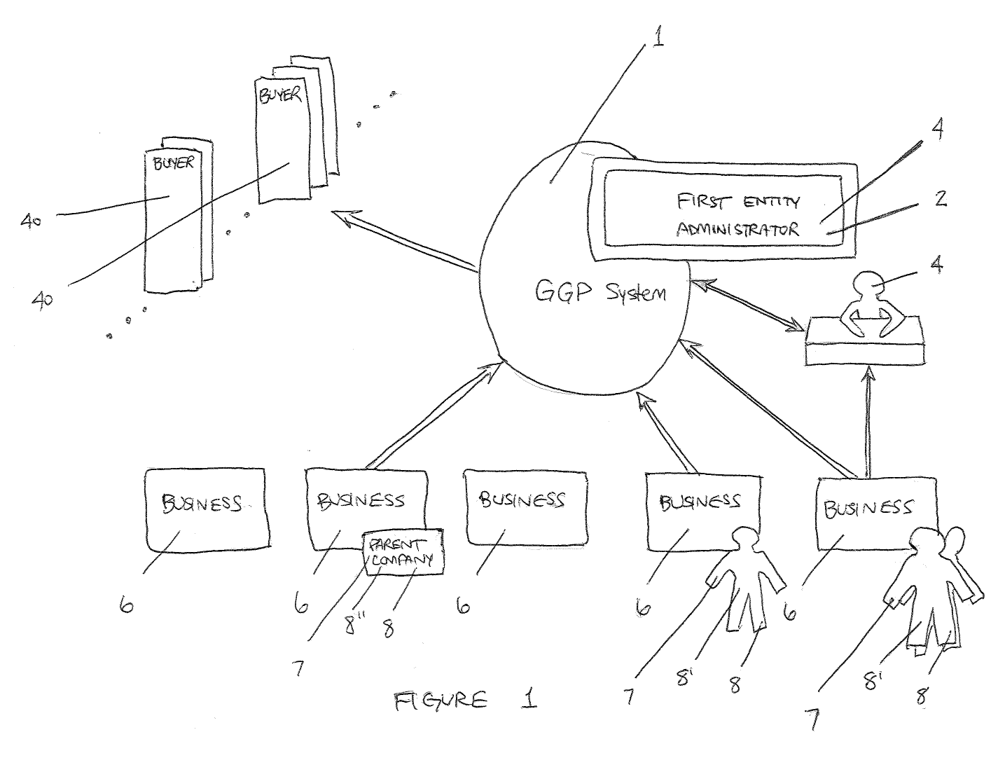

Referring now to the drawings wherein the showings are for purposes of illustrating embodiments of the invention only and not for purposes of limiting the same, FIG. 1 shows a network for brokering businesses and/or guaranteeing the sale of a business that incorporates a guaranteed purchase price system 1. The guaranteed purchase price system 1 may be implemented by a first entity 2 acting as a business broker 4 having a plurality of contacts from which to solicit the sale of a business 6. The first entity 2 may also be a party different from that of a business broker 4 that administrates the guaranteed purchase price system 1. That is to say that the first entity 2 may not function as a business broker or in any capacity as a selling agent of a business 6 but may work independently from a business broker 4. Accordingly, the first entity 2 may be an investment group or investment party, entrepreneur, business consultant and/or the like. Any type of individual or group with any background may function to implement and/or administrate the guaranteed purchase price system 1 as is appropriate for use with the embodiments of the subject invention. In one embodiment, the business owner 8, which may be a single individual or group of individuals 8′ or an another entity 8″, intending to sell their business 6 may contact the first entity 2 to enter their business 6 into the guaranteed purchase price system 1 for sale to another entity. The guaranteed purchase price system 1 may comprise a system of components utilizing logic processor based hardware and a wide area network 30, such as the Internet 32, which may be used to facilitate implementing the embodiments of the subject methods of selling a business 6. The guaranteed purchase price system 1 valuates a business 6 and calculates a plurality of values or prices including one for the offer price OP in the sale of the business and one for the guaranteed purchase price GPP for a “put option” to be discussed in detail below. It is noted that values may include cash flow analyses or other types of assessments. Operating data 22 about the business may be entered into the guaranteed purchase price system 1 for use in the calculation process. Values or prices generated by the guaranteed purchase price system 1 may then be incorporated into an agreement between the parties for use in the sales process as will also be described further below. The business 6 may then be listed for a listing period. If the business 6 has not sold within a prescribed time limit within the listing period, the business owner 8 may exercise the “put option,” which guarantees the sale of the business 6 at the guaranteed purchase price GPP. It is contemplated in an alternate embodiment that the business 6 may be listed for sale by an entity other than the first entity 2. Accordingly, the business owner 8 may be represented by an agent or business broker 4 and as such it may be the business owner's agent or broker who enters into the relationship with the first entity 2 and is responsible for entering and updating all information into the guaranteed purchase price system 1.

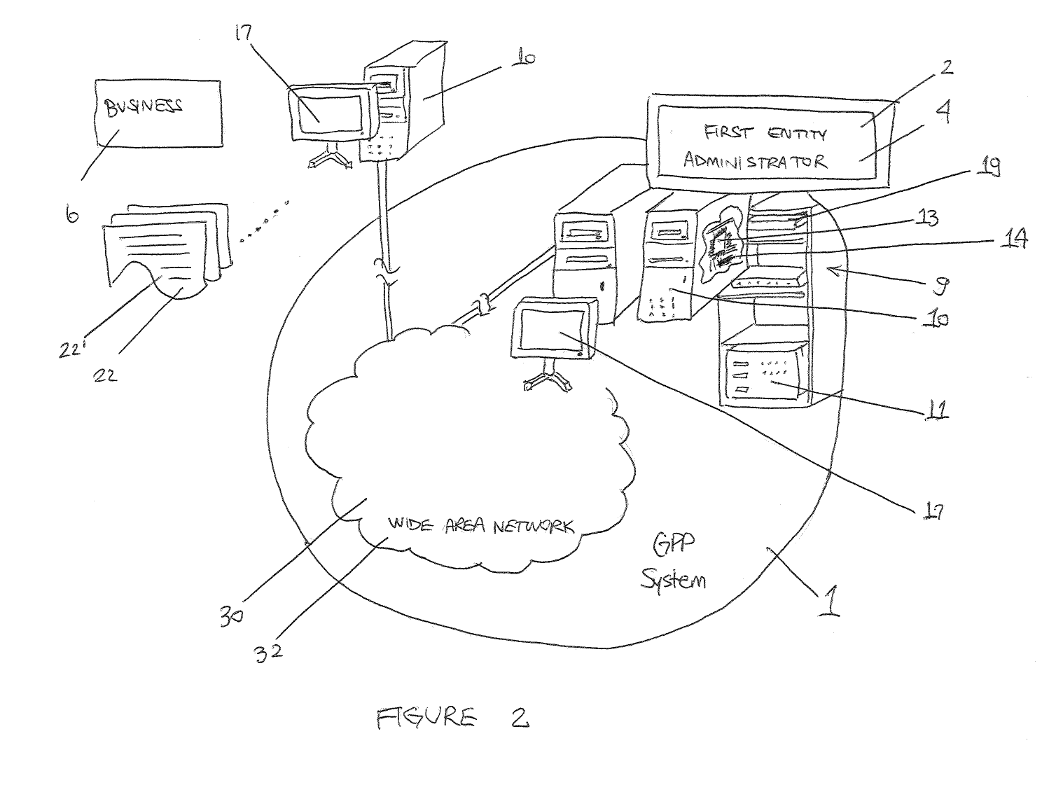

With continued reference to FIG. 1 and now to FIG. 2, as mentioned above the guaranteed purchase price system 1 may include one or more processor based systems 9 such personal computers, servers, work stations, along with portable processor based devices. In one embodiment, the guaranteed purchase price system 1 may comprise a series of processor-based computers 10 networked together to implement the functions of the guaranteed purchase price system 1. In an alternate embodiment, a mini-computer 11 or mainframe computer may be used in accordance with the embodiments of the subject invention. The computers 10 may include, as is well known in the art, one or more microprocessors 13 having support circuitry depicted generally at 14. The support circuitry 14 may include electronic memory, such as RAM or ROM along with other peripheral support circuitry that facilitate operation of the computers 10. The computers 10 may also include data storage devices such as hard disk drives, optical storage devices, flash memory, and the like for the storage and retrieval of operating data 22 and other information calculated from the operating data 22. The computers 10 may further incorporate or be connected to various output devices such as display monitors 17 and printers. It is noted that some of the output devices may reside in a remote location and may not be directly connected to the computers 10 of the guaranteed purchase price system 1. The computers 10 may utilize any type of input device for the processing of operating and other data such as keyboards, scanners, and bar code readers, all not shown. Still, any type of computer related I/O (Input/Output) device that facilitates the processing of information with the computers 10 may be chosen with sound engineering judgment. The guaranteed purchase price system 1 may further include network cards and/or transceivers for connecting to a wide area network 30 or Internet 32. The connection to the wide area network 30 may be both a direct connection via various hardwire connections or connection through wireless communication networks. It is noted at this point that any communication protocol may be used to transmit information to and/or from the components of the guaranteed purchase price system 1. In that the construction of computers and the use of peripheral equipment are well known, no further explanation will be offered at this time.

With continued reference to FIG. 2, the computers 10 used in the guaranteed purchase price system 1 may include workstation and/or server computers connected together by way of various switches or hubs 19. In one embodiment of the subject invention, the computers 10 may be rack-mounted computers located in a single facility. Alternatively, the computers 10 of the guaranteed purchase price system 1 may be located at different facilities, being interconnected via a network, which may be a closed or dedicated network. However, it is noted that any manner of securely setting up communication between the computers 10 of the guaranteed purchase price system 1 may be chosen with sound engineering judgment as is appropriate for use with the embodiments of the subject invention.

Various software modules may be installed onto the computers 10 of the guaranteed purchase price system 1. The software modules may be programmed in any high or low level programming language as is appropriate for use with the embodiments of the subject invention. In one embodiment, the modules may be accessible via the Internet 32 where portions of the modules may be programmed in a mark-up language like HTML or XML. In this manner, the modules may facilitate the interaction of subscribers or users of the guaranteed purchase price system 1 over the Internet 32 as will be discussed in detail in the following paragraphs. Subscribers may include business owners 8 and/or their representatives, potential buyers of a business or representatives of a buying entity 40, financing entities 50 and their assigns or representatives of the business broker 4. Accordingly, security hardware and software may be incorporated to authenticate the subscribers of the guaranteed purchase price system 1. In that not all of the users require access to the same type data with the guaranteed purchase price system 1, security measures may be implemented to limit access of a particular subscriber to subsets of the data or to those modules for which the subscriber 5 needs to view and/or enter data. Accordingly, the guaranteed purchase price system 1 may be a processor based network operating to implement the methods of the subject invention and the interaction of the subscribers or users as described herein.

With reference again to FIG. 1, upon contacting the first entity 2 or business broker 4, the business owner 8 may be set up as a user in the guaranteed purchase price system 1. The business owner 8 may then be directed to enter operating data 22 about the business 6 that the business owner 8 intends to sell. Such operating data 22 may include information related to profits from multiple years of operation as may be verified from audited financials or other documents, inventory, accounting information such as accounts receivable (A/R) and accounts payable (A/P), legal information including threatened and/or pending litigation, various depreciation and amortization schedules, and the like. It is noted here that the above listed data are exemplary in nature. Any type of information about the historical or current operating status of the business 6 may be entered into the guaranteed purchase price system 1 as chosen with sound judgment. The business owner 8, as a user, may have access to the guaranteed purchase price system 1 from a remote location via the Internet 32 as described above. In this manner, the business owner 8 may enter the operating data 22 from a remote location and at any time conducive to the business owner's schedule. Operating data 22 may then be updated into a database of the guaranteed purchase price system 1 in substantially real time and made readily available for processing and/or for access by other authorized users. By database it is meant any compilation of data stored within the computer 10 as managed by a data storage and retrieval program.

Once the operating data 22 for a given business 6 has been entered, a business listing or other report may then be disseminated for proposal to a buying entity or buyer 40. Buyer may refer to individuals, groups of individuals and/or other entities interested in purchasing a business 6 from the business broker 4. The buyer 40 may be qualified as having a bona fide interest in buying a business 6 from the business broker 4 by any process suitable for use with the embodiments of the methods and systems of the subject invention. It is noted that a buyer 40 may or may not actually complete the transaction of buying the business 6 but may simply be interested in buying a business 6 from the business broker 4. The buyer 40 may also be set up as a user of the guaranteed purchase price system 1 and given access to various data stored in the computer 10. As described earlier, the type of data that the buyer 40 may be authorized to view may relate to selected operating data 22 about one or more businesses or calculated information about a business 6. It will be appreciated by persons of ordinary skill in the art that any type of search engine may be used to sort the data for presentation to the buyer 40 and other users of the guaranteed purchase price system 1. Some of the information available to the buyer 40 may include but is not limited to the offer price OP, cash flow analysis or various historical data about one or more businesses 6 entered into the guaranteed purchase price system 1. Similar to the business owner 8, the buyer 40 may have 24-hour access to the guaranteed purchase price system 1, and any associated and properly authorized data therein, from a remote location.

With reference again to FIGS. 1 and 2, the guaranteed purchase price system 1 may include an algorithm that processes the operating data 22 from one or more business owners 8 that list their respective business 6 with the guaranteed purchase price system 1 for sale to a buyer 40. The algorithm may be functional to access the operating data 22 for a given business 6 and calculate or derive an offer price OP, or a range of offer prices, based on the values of the data entered. In this manner, the algorithm may be communicated to the database for processing or deriving results based on the information about the listed business 6. For example, the offer price may be based on one or more methods of valuating a business including asset valuations and income valuations.

Asset valuations may consider the business 6 to be a collection of assets that have a marketable value to another party or buyer 40 in an asset sale. At a minimum, a business 6 should be valued at the sum of the value of its easily salable parts. Commonly used business valuation methods look primarily at the value of the hard assets of a business 6. Asset valuations may be used for specific types of businesses such as holding companies and investment companies. However, the algorithm may use asset valuations to generate an offer price for any type of business being sold in conjunction with the guaranteed purchase price system 1. Asset valuation methods may include a variety of other methods for generating an offer price including but not limited to: the book value method, the adjusted book value method, the economic balance sheet method, and the liquidation method.

Income valuations may be based on the current value of a business which is a function of the future value that a buyer 40 could expect to receive from purchasing part or all of the business 6. Financial statements and accounting records have traditionally provided the basis for determining the value of a business 6 as accounting records are generally considered to be prepared in an unbiased manner. Income valuation methods may comprise the capitalization of earnings method, the discounted future income method, the discounted cash flow method, the economic income method, along with other formula methods. Accordingly, the starting point for methods of this type may recast historical financial data to show how the business 6 may have looked without the compensation above what a non-owner manager might be paid and without non-operating and/or nonrecurring expenses. Some factors for deriving a valuation method may be subjective. That is to say that a person of ordinary skill in the art may determine whether a valuation is based on the previous year's statements, or at some combination of statements from the last three to five years. Frequently combinations including a simple average, a weighted average that values the most recent years more heavily, or a trend line that factors in the percentage and direction of growth each year are used to determine the valuation of the business. It is noted here that while the aforementioned methods are described as being utilized to valuate a business 6 and generate an offer price OP, any method may be used as chosen with sound financial and business principals to valuate a business 6 and generate an offer price OP or other valuation data for a business 6.

As such, one or more methods for valuating a business 6 may be used to program an algorithm to automatically generate an offer price OP for a buyer 40. In one embodiment, the process of entering operating data 22 about a respective business 6 and generating an offer price OP may be iterative. That is to say that the business owner 8 may enter a first set of operating data 22 into the guaranteed purchase price system 1 and generate an offer price OP for review. The business owner 8 may subsequently modify the operating data 22 to see how the offer price OP may differ respective of the changes made. The guaranteed purchase price system 1 may provide a step of finalizing the entered operating data 22 to allow the user, i.e. business owner 8, to play a series of “what-if” scenarios. Accordingly, when the business owner 8, and/or representatives and consultants, are satisfied with how the operating data 22 have been recast, they may finalize the offer price for presentation to buyers 40 or other users of the guaranteed purchase price system 1. It is noted here that the business owner 8 may update the operating data 22 as needed or as the operating data 22 about the business 6 fluctuates. Upon changes in the operating data 22 and/or the offer price OP, the guaranteed purchase price system 1 may automatically generate a notification to the user interested in that particular business 6 that a change has occurred. It is to be construed that generating an offer price OP is exemplary in nature and as such any type of information may be generated from the operating data 22 including but not limited to cash flow analyses and the like.

In an alternate embodiment, the process of recasting operating data may be run on theoretical basis. That is to say that at any point in the process of selling the business 6, the business owner 8 may enter theoretical operating data 22′ about the business 6 into the guaranteed purchase price system 1 to generate pricing and other related information about the business 6 being sold. In this way, a theoretical response may be generated based on the theoretical operating data 22′ about the business 6. The business owner 8 may use the information to help operate the business 6 or for any other purpose chosen with sound business judgment. In other words, the guaranteed purchase price system 1 may provide a tool for the business owner 8 to help understand how changes in the operation of the business 6 might affect its profitability, operation or value to a prospective purchaser.

With reference now to FIGS. 1 through 4a, the first entity 2 or business broker 4 may offer the business owner 8, otherwise referred to as a seller 7, a “put option.” The “put option” may guarantee the seller 7 that if their business 6 is not sold by a prescribed point in time during the listing period, the business owner may exercise the “put option” to have their business acquired through the guaranteed purchase price system 1. For example, the seller 7 may choose to list their business 6 on the guaranteed purchase price system 1 for specific time period, which may be 12 months. If the subject business 6 does not receive a bona fide offer by the end of the 11^{th} month of the listing period, the seller 7 may exercise the “put option,” which guarantees that the first entity 2 or business broker 4 will purchase the business 6 or find a third party purchaser 43 to purchase the business 6 at the guaranteed purchase price GPP. In one embodiment, the guaranteed purchase price GPP may be lower than the offer price OP by a predetermined range. For example, the guaranteed purchase price GPP may be 50% to 90% of the offer price OP and more specifically may be in the range of 70% to 85% of the offer price OP. However, any method of calculating the guaranteed purchase price GPP may be chosen with sound engineering judgment including methods based on the operating data 22. Accordingly, the first entity 2 or business broker 4 may find a third party purchaser 43 or may be obligated to purchase and operate the subject business 6 until another buyer 40 can be found.

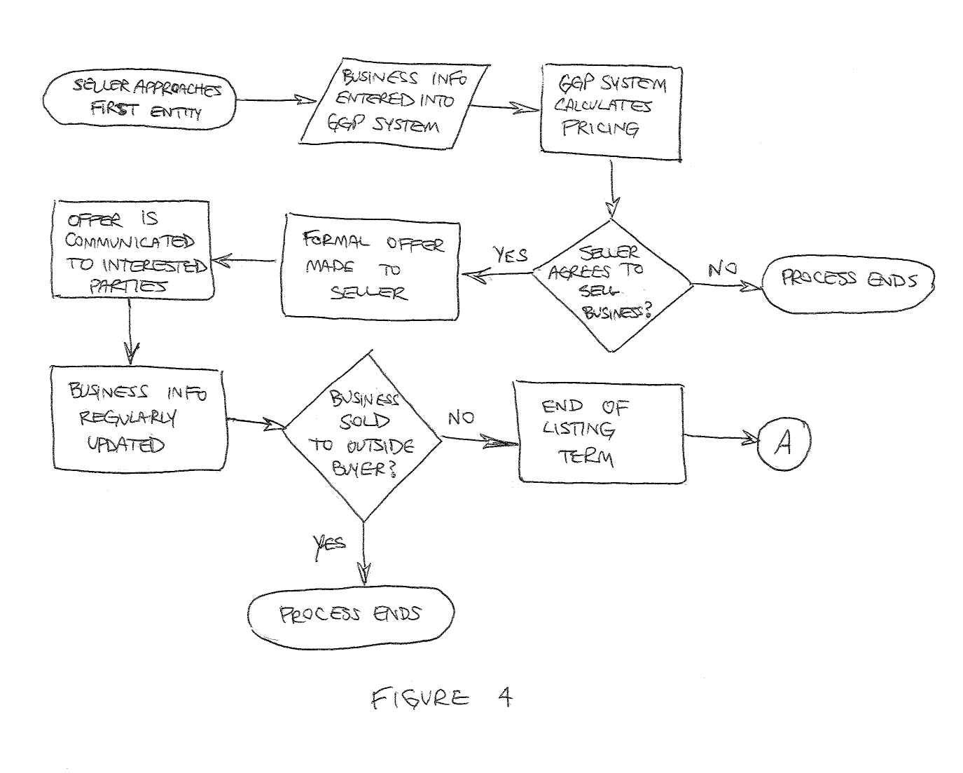

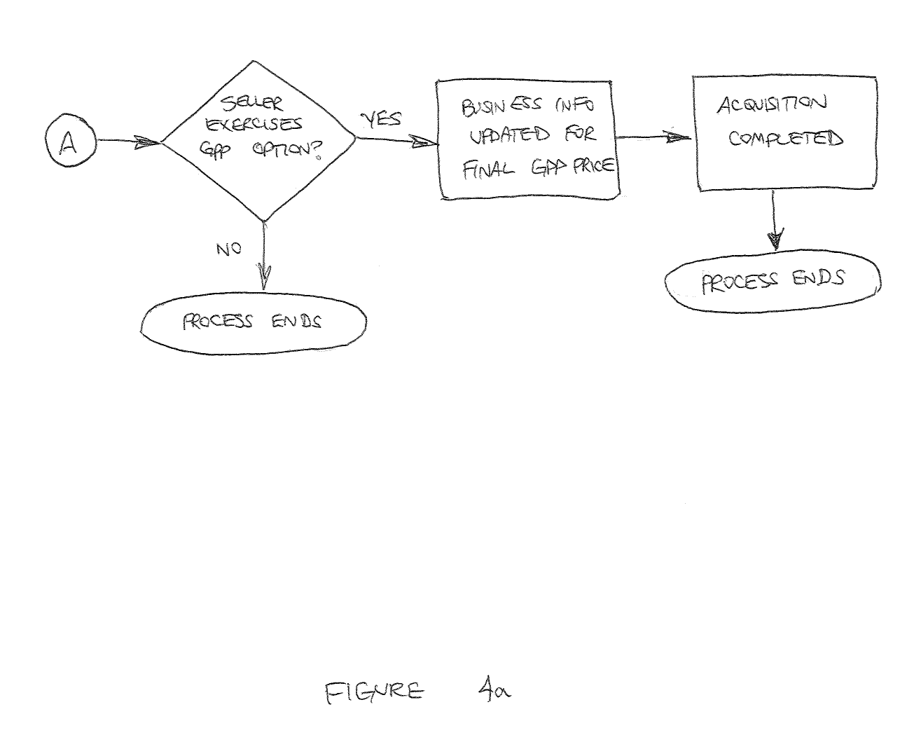

FIGS. 4 and 4a show one embodiment of the sequence of events of the guaranteed purchase price system 1. The seller 7 may approach the business broker 4 to sell a business 6 and may be given access to the guaranteed purchase price system 1 as a user of the system via an account ID and password. The seller 7 may then enter operating data 22 about the business 6 into a database stored in one or more computers 10 of the guaranteed purchase price system 1. A program coded to valuate the business 6 based on the input data may return an offer price OP for review by the seller 7. The seller 7 may then recast the operating data 22 to modify the offer price OP. If an offer price can be agreed upon by both the seller 7 and the business broker 4, the seller 7 and business broker 4 agree and contract to list the business 6 for sale on the guaranteed purchase price system 1, which may include the “put option.” If an agreement cannot be arrived at, the user account of the seller 7 may be deactivated or maintained for later use. It will be appreciated by persons of ordinary skill in the art that other contractual provisions may be included in the agreement between seller 7 and the business broker 4. Any additional contractual conditions may be implemented as chosen with sound judgment. The business broker 4 may subsequently formally present the offer to seller 7 including the “put option” listing the guaranteed purchase price GPP. The business 6 may then be listed on the guaranteed purchase price system 1 for review by other users including buyers 40 having access to the guaranteed purchase price system 1.

Once the business 6 is listed for sale, buyers 40 may view operating data 22 about the business 6 on line or download prospectus information as desired from the guaranteed purchase price system 1. The guaranteed purchase price system 1 may include software modules or other program subroutines that search and sort data related to the plurality of businesses 6 listed in the guaranteed purchase price system 1. Reports may be generated that update the buyers 40 to changes in operating data 22, offer price OP or any data related to the businesses 6 that a particular buyer 40 may be interested in. The reports may be automatically generated and communicated via e-mail or other electronic data transfer means. Alternatively, message indicators may be activated when a particular user logs onto the guaranteed purchase price system 1. However, it is to be construed that any manner may be used to notify a buyer 40 that information related to a specific business 6 has been updated. If the seller 7 receives an offer to purchase the business 6 within a range proximate to the offer price OP, the seller 7 may be obligated to accept the bid offer or have the “put option” with the guaranteed purchase price extinguished. In one embodiment, the minimum bid offer may extend to substantially 5% below the offer price OP. However, it is noted that any guaranteed purchase price and any minimum bid offer amount may be chosen as is appropriate for use with the embodiments of the subject invention. The seller 7 may accept the bid amount and work with the new buyer 40 to finalize the remaining terms of the sale agreement. Commissions may be paid to the business broker 4 and the guaranteed purchase price system 1 may be updated with the appropriate data wherein the account for the subject listing may be closed.

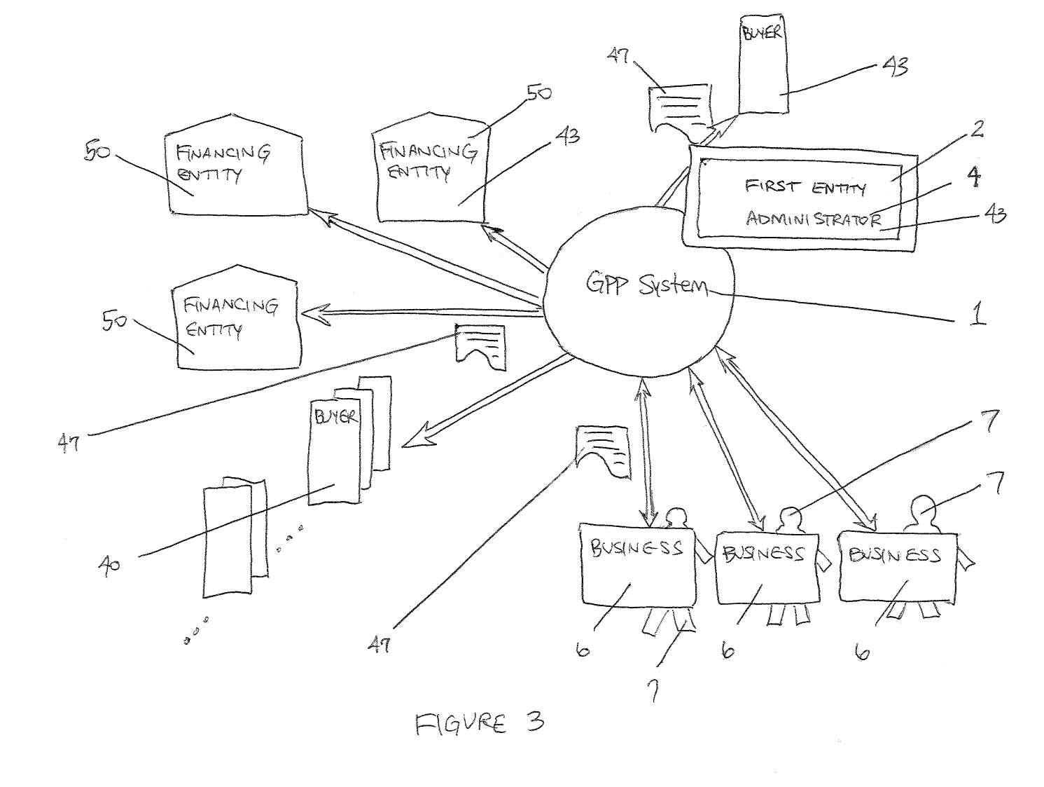

With reference now to all of the Figures and in particular FIG. 3, the first entity 2 or business broker 4 may bring together additional parties to meet the obligations of the “put option.” As previously described, if the seller 7 does not receive a bona fide offer to purchase the seller's business 6, the “put option” guarantees the sale of the business 6. In one embodiment, the business broker 4 may purchase the business 6 for the guaranteed purchase price GPP. Terms of the sale may include stipulations relating to the down payment and finance terms, For example, the contract may require a down payment of no more than 25% of the guaranteed purchase price with finance terms extending up to seven (7) years. However, any terms of the “put option” may be included in the contract between the seller 7 and the business broker 4 as is appropriate for use in the embodiments of the subject invention. The business broker 4 may choose to operate the business 6 indefinitely or until the business 6 can be resold. Accordingly, the business broker 4 may work with one or more financial institutions or financing entity 50 to prearrange financing for businesses 6 that have the “put option.” The financing entity 50 may also be set up as a user of the guaranteed purchase price system 1, which provides the financing entity 50 access to information such as bid information for select businesses 6 and aging reports as will be described in detail below. It is noted that a financing entity 50 may be a traditional bank. However, financing entities 50 may also include individuals or groups like venture capitalists. Still any type of financier may be considered as a financing entity 50.

The business broker 4 may also bring together other third party purchasers 43. The third party purchasers may be existing business owners, entrepreneurs, or any party willing to purchase a business 6 for the guaranteed purchase price if the “put option” for that particular business is exercised. It is noted here that a financing entity 50 may also function as third party purchaser 43. The third party purchasers 43 may be set as users in the guaranteed purchase price system 1 and may have access to any or all of the business listings. The business broker 4 may qualify each third party purchaser 43 for a particular business 6. That is to say the business broker 4 may select a particular third party purchaser 43 whose experience and financial standing match the business 6. In one embodiment, the business broker 4 may subject new incoming businesses 6 to a screening process. If the business broker 4 is not interested in that business 6 and/or if a third party purchaser 43 cannot be qualified for that business, the seller 7 may not be eligible for the “put option.” The business 6 may still be listed with the business broker 4 for sale to another party and the seller 7 may be set up as a user of the guaranteed purchase price system 1. However, the sale of the business 6 may proceed in a traditional fashion.

As mentioned above, the guaranteed purchase price system 1 may include computers 10 programmed to accept users for communicating details about the status of the sales pending. The guaranteed purchase price system 1 may include a report generator for forwarding reports 47 to the various users of the guaranteed purchase price system 1. The reports 47 may be electronically generated and forwarded to the users via e-mail. Users may also access the reports 47 when logged into the guaranteed purchase price system 1. Alternatively, hardcopies of pertinent data may be printed and sent to the users via mail or fax. Any manner of generating and forwarding reports 47 generated by the guaranteed purchase price system 1 may be chosen with sound judgment as is appropriate for use with the embodiments of the subject invention. The reports 47 may be customized to the individual users. In this manner, the guaranteed purchase price system 1 may distinguish between the users and their particular level of access to data within the system, For example, seller 7 may only have access to bid data related to the business 6 that is listed by that seller 7. Financing entities 50 or third party purchasers may have access to data for businesses 6 listed on the system that affect their financial obligations. Buyers 40 may receive periodic updates if operating data 22 about a particular business 6 has been modified. Still, any type of report and quantity of information may be configured and available for review by an authorized user of the guaranteed purchase price system 1. In one embodiment, the guaranteed purchase price system 1 may also monitor bid information received by a seller 7. Conditions or rules may be programmed into the guaranteed purchase price system 1 to automatically determine if the “put option” has been extinguished. For example, if a seller 7 rejects a bid above the offer price OP, the guaranteed purchase price system 1 may automatically generate a report to the business broker 4, or other user, that the “put option” has been extinguish because the seller 7 has rejected the bid. The business broker 4 may subsequently determine to reinstate the “put option” if desired.

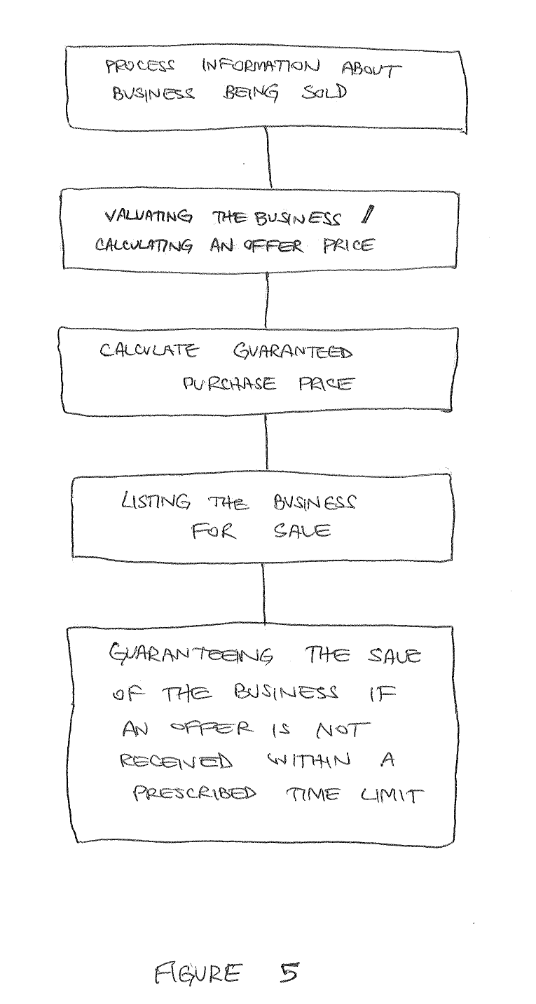

With reference to FIG. 5, a method of selling a business 6 with a guaranteed purchase option will now described. A business owner 8, or seller 7, may approach the first entity 2, or a business broker 4 offering to list and sell the business owner's business 6. The business owner 8 may submit operating data 22 about the business 6 valuating and calculating an offer price OP or other cash flow data and a guaranteed purchase price GPP. If the offer OP can be agreed upon by the parties, an agreement may be executed and the business 6 listed for sale by the business broker 4. The business 6 and/or the business owner 8 may be screened and qualified for the “put option,” guaranteeing the sale of the business 6 if a bona fide offer is not received by a predetermined time. If the business 6 is sold or if an offer is received having a minimum threshold bid, the “put option” may be extinguished. If no bid is received, the business broker 4 may purchase or a third party purchaser 43 may purchase the business 6 for the guaranteed purchase price.

It is contemplated in another embodiment that a business owner 8, or seller 7, may offer his business 6 for sale by one or more sales channels, including but not limited to using a business broker 4 where the sales agent is different from the first entity 2 or administrator of the guaranteed purchase price system 1. In other words, the first entity 2 is distinctly separate from the business broker 4 or the other channels for selling the business 6. The business owner 8 may separately approach the first entity 2 administrating the guaranteed purchase price system 1 and may submit operating data 22 about the business 6 for calculation of a guaranteed purchase price GPP. The business 6 and the business owner 8 may be screened and qualified for the “put option” thereby guaranteeing the sale of the business if a bona fide offer is not received by a predetermined time. Similar to the previous embodiment, if the business 6 is sold or if an offer is received having a minimum threshold bid, the “put option” may be extinguished. If no bid is received, the first entity 2 may purchase or another third party purchaser 43 may purchase the business 6 for the guaranteed purchase price GPP. It is expressly noted that the one or more sales channels may be different than and separate from the first entity 2. Thus, two distinct entities may be involved in the process of selling and guaranteeing the sale of a business 6. The “put option” may also be provided so long as the business owner 8 agrees to list the business for sale for a period of time through any reasonable method including newspaper advertisements, websites, other broker networks or any other means of selling a business. Moreover, the business owner 8 may not be required to list the business for sale at all as discussed below.

In another embodiment, there may not be a sales channel at all, which is to say that the business owner 8 may not be placing the business 6 up for sale to a buyer 40. However, the business owner 8 may approach the first entity 2 to execute the steps of the guaranteed purchase price system 1 to determine a guaranteed purchase price GPP. Despite the fact that the business 6 is not being offered for sale, the business owner 8 may decide engage the first entity 2 to implement the “put option” for a period of time. Accordingly, the business owner 8 may choose to exercise the “put option” thereby selling the business 6 to the first entity 2 or another third party purchaser 43. Of course, it will be realized that in this instance, the business owner 8 is accepting the guaranteed purchase price GPP as opposed to an offer for sale by a qualified buyer 40. As such, it is expressly noted that participation in the guaranteed purchase program may not require the business owner 8 to list the business for sale with the guaranteed purchase price system 1 or with the business broker 4 associated with the guaranteed purchase price system 1.

The business owner 8 may be required to pay a fee for implementing the “put option” in accordance with any of the embodiments listed herein. The fee may be a flat rate or may be calculated by the guaranteed purchase price system 1 based on such factors as the offer price, operational factors relating to the business such as free cash flow, the number of months that the business owner 8 agrees to list the business 6 with the broker network, the number of months that the business wants to have the “put option” last. Any other factors may be used to determine the price that would be charged for providing the “put option.” Additionally, all or part of the fee itself may be waived by the first entity 2 for any factors chosen with sound business judgment as is appropriate for the embodiments of the subject invention, including but not limited to, fees paid for other services provided by the first entity 2 or other entities to the business owner 8.

The invention has been described herein with reference to the preferred embodiment. Obviously, modifications and alterations will occur to others upon a reading and understanding of this specification. It is intended to include all such modifications and alternations in so far as they come within the scope of the appended claims or the equivalence thereof.

What is claimed is:

1. A method for guaranteeing the sale of a business, comprising the steps of:
providing a processor based network operable to store and retrieve operating data about a business being offered for sale;
receiving operating data from the business;
storing the operating data in a database within the processor based network;
calculating an offer price for the business based on the operating data;
calculating a guaranteed purchase price for the business; and,
guaranteeing the sale of the business for the guaranteed purchase price.

2. The method as defined in claim 1, wherein the step of guaranteeing the sale of the business for the guaranteed purchase price, further comprises:
providing an option to sell the business at the guaranteed purchase price thereby guaranteeing the sale of the business.

3. The method as defined in claim 2, wherein the step of providing an option to sell the business at the guaranteed purchase price thereby guaranteeing the sale of the business, further comprises:
providing an option to sell the business at the guaranteed purchase price when the business does not receive a minimum bid offer thereby guaranteeing the sale of the business.

4. The method as defined in claim 2, wherein the step of providing an option to sell the business at the guaranteed purchase price thereby guaranteeing the sale of the business, comprises the step of:
providing an option within a prescribed time limit to sell the business at the guaranteed purchase price thereby guaranteeing the sale of the business.

5. The method as defined in claim 4, further comprising the step of:
prearranging a third party purchaser to purchase the business at the guaranteed purchase price when the business is not sold with the prescribed time limit.

6. The method as defined in claim 1, wherein the processor based network is administrated by a first entity, and wherein the first entity is a business broker.

7. The method as defined in claim 6, further comprising the step of:
listing the business for sale on the processor based network.

8. The method as defined in claim 1, wherein the processor based network is administrated by a first entity, and wherein the business is being sold by an entity other than the first entity.

9. The method as defined in claim 1, further comprising the step of:
providing an algorithm operable to process the operating data, wherein the algorithm is stored on the processor based network; and wherein the step of calculating an offer price, comprises the step of:
automatically calculating an offer price for the business based on the operating data.

10. The method as defined in claim 9, wherein the step of calculating a guaranteed purchase price, comprises the step of:
automatically calculating a guaranteed purchase price based on a percentage of the offer price.

11. The method as defined in claim 9, wherein the step of calculating a guaranteed purchase price, comprises the step of:
automatically calculating a guaranteed purchase price based on the operating data.

12. The method as defined in claim 1, further comprising the steps of:
updating the operating data from the business; and,
recalculating the offer price based on the updated operating data.

13. The method as defined in claim 1, further comprising the steps of:
receiving theoretical operating data; and,
generating one or more theoretical responses based on the theoretical operating data.

14. The method as defined in claim 1, further comprising the steps of:
generating at least a first report from the processor based network.

15. The method as defined in claim 14, wherein the at least a first report is at least a first aging report.

16. The method as defined in claim 1, further comprising the steps of:
authorizing one or more users to access the processor based network; and,
restricting access of the one or more users to information stored in the database.

17. The method as defined in claim 1, wherein the processor based network comprises:
one or more computers having memory storage and at least a first microprocessor.

18. A method of buying a business, comprising the steps of:
receiving operating data about a business being offered for sale;
calculating an offer price for the business based on the operating data;
calculating a guaranteed purchase price for the business; and,
guaranteeing the sale of the business for the guaranteed purchase price.

19. The method as defined in claim 18, wherein the step of guaranteeing the sale of the business for the guaranteed purchase price, further comprises:
providing an option to sell the business at the guaranteed purchase price thereby guaranteeing the sale of the business.

20. The method as defined in claim 18, wherein the step of providing an option to sell the business at the guaranteed purchase price thereby guaranteeing the sale of the business, further comprises:
providing an option to sell the business at the guaranteed purchase price when the business does not receive a minimum bid offer thereby guaranteeing the sale of the business.

21. The method as defined in claim 20, further comprising the step of:
prearranging a third party purchaser to purchase the business at the guaranteed purchase price if the business is not sold with a prescribed listing time period.

22. The method as defined in claim 18, further comprising the step of:
listing the business for sale via a brokerage network for a prescribed listing time period.

23. The method as defined in claim 18, wherein calculating a guaranteed purchase price for the business is based on the operating data.

24. The method as defined in claim 18, wherein the guaranteed purchase price is between 50% and 90% of the offer price.

25. The method as defined in claim 24, wherein the guaranteed purchase price is between 70% and 85% of the offer price.

26. The method as defined in claim 18, wherein the operating data about a business includes financial data verified from audited financials.

27. The method as defined in claim 18, further comprising the step of:
extinguishing the guarantee of the sale.

28. The method as defined in claim 27, wherein the step of extinguishing the guarantee of the sale, comprises the step of:
extinguishing the guarantee of the sale responsive to receiving a minimum bid offer from a buyer.

29. A method for guaranteeing the sale of a business, comprising the steps of:
receiving operating data from a business intending to be sold to a buyer;
valuating the business based on the operating data;
calculating a guaranteed purchase price for the business; and,
providing an option to sell the business at the guaranteed purchase price when the business does not receive a minimum bid offer.

30. The method as defined in claim 29, wherein the step of valuating the business based on the operating data, comprises the step of:
calculating an offer price for the business thereby valuating the business based on the operating data.

31. The method as defined in claim 29, wherein the step of valuating the business based on the operating data, comprises the step of:
deriving a cash flow analysis for the business thereby valuating the business based on the operating data.

32. The method as defined in claim 29, further comprising the step of:
charging a fee for providing the option to sell the business at the guaranteed purchase price.

33. The method as defined in claim 32, wherein the fee for providing the option to sell the business at the guaranteed purchase price is based one or more factors including:
valuating the business, the number of months that the option to sell the business at the guaranteed purchase price will last, or the length of time that the business will be listed for sale.
